(19) United States
(12) Patent Application Publication
(10) Pub. No.: US 2004/0076428 A1
(43) Pub. Date: Apr. 22, 2004

(54) Form existing fibers into a fibre channel-arbitrated loop

(75) Inventors: Samuel I. Green, St. Louis, MO (US); Steven H. Wilson, Manchester, MO (US)

Correspondence Address: DIPINTO & SHIMOKAJI, P.C., 1301 Dove Street, Suite 480, Newport Beach, CA, 92660, US

(73) Assignee: The Boeing Company, Seattle, WA

(21) Appl. No.: 10/153,835

(22) Filed: May 20, 2002

(51) Int. Cl. H04B 10/08; H04J 14/00

(52) U.S. Cl. 398/9

(57) ABSTRACT

A system for image data communication in military aircraft between a graphics processor computer, referred to as the computer node, and weapons carried on wing pylons, referred to as remote nodes, includes a hub connected via fiber pairs to the computer node and to the remote nodes. The hub includes a number of port bypass switches connected in a bypass loop so that each port bypass switch conveys data between the computer node and the hub or between the remote node and the hub when in a first state, and each port bypass switch conveys data within the bypass loop in the hub, i.e. bypassing its node, when in a second state.

### BACKGROUND OF THE INVENTION

The present invention generally relates to data communication using optical fibers and, more particularly, to a versatile arrangement for conveying data between a computer Fibre Channel node and a number of other Fibre Channel nodes.

Modern military aircraft require some means to convey image data between the mission computer or other graphics processor computer and weapons mounted to the wing pylons. For example, some military aircraft, such as the F/A-18E/F, could advantageously use wide bandwidth imaging from the graphics processor or processors to the weapons pods, or wing pylons, for real-time targeting of smart weapons. Such wideband imaging could be accomplished, for example, by using fiber optic technology. Fiber optic technology has several advantages over conventional electronic technology including less weight and greater bandwidth allowing higher data rates, i.e., greater speed of data transmission, to be achieved.

Fiber optic technology is currently used on some military aircraft for other applications and may include a switch, referred to as a “fabric switch” for switching data signals through and between the optical fibers. Preferably, transferring imagery data at a high data rate using a wide bandwidth to and from MIL-STD-1760 weapons mounted to wing pylons would use existing MIL-STD-1760 fiber pairs installed within the aircraft. Ideally the existing MIL-STD1760 fiber pairs would be used to form a new bus or network able to meet the need for transferring high rate imagery data between MIL-STD-1760 weapons mounted to the wing pylons and the graphics processor.

The bandwidth multiplying power of a fabric switch, however, is not needed for transferring high rate imagery data to and from the weapons and the graphics processor. Furthermore, the use of additional fabric switches undesirably increases the expense and weight of the aircraft.

As can be seen, there is a need for a high data rate, wide bandwidth connection for conveying imagery and targeting data between graphics processors and weapons in military aircraft. Also, there is a need in military aircraft for a high data rate, wide bandwidth connection which can connect a graphics processor to several weapons and which can also connect a processor to one weapon at a time. Moreover, there is a need for a connection that can use existing fiber pairs installed in the aircraft during manufacture.

### SUMMARY OF THE INVENTION

The present invention provides a high data rate, wide bandwidth connection for conveying imagery and targeting data between the graphics processor or processors and the weapons in military aircraft. The present invention also provides a high data rate, wide bandwidth connection which can connect a computer to several weapons and which can also connect a computer to one weapon at a time. Moreover, the present invention provides a connection that can use existing fiber pairs installed in the aircraft during manufacture.

In one aspect of the present invention, a system for image data communication between a plurality of Fibre Channel nodes includes a hub comprising a plurality of port bypass switches and a plurality of fiber pairs, wherein each of the plurality of Fibre Channel nodes is connected by a corresponding one of the plurality of fiber pairs to a corresponding one of the plurality of port bypass switches. Each of the plurality of port bypass switches is configured to convey data between the hub and a corresponding one of the plurality of Fibre Channel nodes in a first state and to convey data within the hub in a second state.

In another aspect of the present invention, a system for data communication between a computer and a plurality of weapons carried on wing pylons includes a hub connected via fiber pairs to each of a plurality of Fibre Channel nodes. At least one of the plurality of Fibre Channel nodes comprises a computer and at least one of the plurality of Fibre Channel nodes comprises a weapon carried on a wing pylon. The hub comprises a plurality of port bypass switches, the plurality of port bypass switches being connected in a bypass loop, and each of the plurality of port bypass switches is configured to convey data between the hub and a corresponding one of the plurality of Fibre Channel nodes in a first state and to convey data within the bypass loop in a second state.

In still another aspect of the present invention, an apparatus for data communication between a plurality of Fibre Channel nodes includes a hub connected via fiber pairs to a plurality of Fibre Channel nodes. At least one of the plurality of Fibre Channel nodes comprises a computer and at least one of the plurality of Fibre Channel nodes comprises a weapon carried on a wing pylon. The hub comprises a plurality of port bypass switches; each of the plurality of port bypass switches connects to a corresponding one of the plurality of Fibre Channel nodes; and at least two of the plurality of port bypass switches are connected to each other. Each of the plurality of port bypass switches is configured to convey data between the hub and a corresponding one of the plurality of Fibre Channel nodes in a first state and each of the plurality of port bypass switches is configured to convey data within the hub in a second state.

In yet another aspect of the present invention, an apparatus for data communication between a computer and a plurality of weapons carried on wing pylons comprises a hub connected via fiber pairs to each of a plurality of Fibre Channel nodes. At least one of the plurality of Fibre Channel nodes comprises a computer and at least one of the plurality of Fibre Channel nodes comprises a weapon carried on wing pylon. The hub comprises a plurality of port bypass switches. Each of the plurality of port bypass switches connects to a corresponding one of the plurality of Fibre Channel nodes via an optical transmitter-receiver pair, and each of the plurality of port bypass switches is electronic. The plurality of port bypass switches are connected in a bypass loop; data is conveyed within the bypass loop electronically; each of the plurality of port bypass switches is configured to convey data between the hub and a corresponding one of the plurality of Fibre Channel nodes in a first state; and each of the plurality of port bypass switches is configured to convey data within the bypass loop in a second state so that the plurality of Fibre Channel nodes, the hub, and the fiber pairs connecting the plurality of Fibre Channel nodes and the hub comprise a Fibre Channel-Arbitrated Loop.

In a further aspect of the present invention, a method for data communication between a computer and a plurality of weapons carried on wing pylons includes steps of: conveying the data between the computer and a first of a plurality of port bypass switches in a hub; conveying the data in the hub between the first of the plurality of port bypass switches and a second of the plurality of port bypass switches; and conveying the data between the second of the plurality of bypass switches and one of the plurality of weapons carried on wing pylons using a fiber pair.

These and other features, aspects and advantages of the present invention will become better understood with reference to the following drawings, description and claims.

### BRIEF DESCRIPTION OF THE DRAWINGS

FIG. 1 is a system block diagram of a Fibre Channel-Arbitrated Loop with electronic port bypass switching according to one embodiment of the present invention; and

FIG. 2 is a system block diagram of a Fibre Channel-Arbitrated Loop with fiber optic port bypass switching according to an alternative embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention provides a high data rate, wide bandwidth connection for conveying imagery and targeting data between the graphics processor computer or computers and the weapons in military aircraft. In one embodiment, existing installed fibers are formed into a loop able to convey high rate data using a Fibre Channel-Arbitrated Loop (FC-AL). For example, according to current manufacture, installed fiber pairs may be run between each of the wing pylons and terminate in two multi-fiber connectors at a bulkhead within the fuselage. A wide bandwidth connection for conveying imagery and targeting data between the graphics processor or processors and the weapons may be formed by, first, bringing the two multi-fiber connectors instead to a hub that contains means to form the existing fibers into a loop and to bypass any of the fiber pairs individually, or in any combination. The loop may include one or two additional Fibre Channel nodes in the graphics processor. This arrangement provides the versatility needed to form a complete loop with any combination of Fibre Channel capable nodes in the weapons carried on the wing pylons. For example, a bypass switch may be used to bypass a fiber pair from a wing pylon that has no continuity, that is, the weapon is not Fibre Channel capable, or is not there because it has been released or has not been loaded. The loop may be routed through any combination of nodes and around others by control of the bypass switches. Thus, the present invention provides a high data rate, wide bandwidth connection which can connect one or more computers, i.e., graphics processors, to several weapons and which can also connect a computer to one weapon at a time.

One obvious solution for providing a high data rate connection between graphics processors and weapons would be to use a fabric switch. The bandwidth multiplying power of a fabric switch, however, is not needed for transferring high rate imagery between the weapons and the graphics processor because FC-AL has sufficient capability for weapons targeting imagery. Furthermore, the use of additional fabric switches undesirably increases the complexity, expense, and weight of the aircraft. In one embodiment, the present invention provides the needed ability to transfer high rate imagery data to and from MIL-STD-1760 weapons carried on the wing pylons without running new cables or fibers through the wings. The embodiment provides a connection that can use existing unused MIL-STD-1760 fiber pairs installed in the aircraft and avoids the extra cost and weight penalty for the aircraft of the method of using a fabric switch. The embodiment adds a new weapons replaceable assembly (WRA) containing a hub for the FC-AL within the fuselage and a small, low-power commercial fiber optic transceiver in each wing pylon equipment bay to convert optical video data to electrical video data before reaching the MIL-STD-1760 connector. The purpose of the fiber optic transceiver is to convert the optical signal to an electrical signal within the wing pylon for passing the signal to the electrical Fibre Channel node within the weapon carried on the wing pylon.

One embodiment may be used as follows. During power-up, sequence the bypass switches to bypass all nodes but one to a single wing pylon, and let FC-AL initialize. If successful, there is a Fibre Channel capable weapon at that pylon. Sequence the bypass switches to enable the next wing pylon and repeat. When completed, the graphics processor has a list of operating Fibre Channel compatible nodes. Appropriate switches are enabled to complete an arbitrated loop of the operating nodes. From this point, data can be communicated between any and all operating nodes, and the configuration need not be modified until the configuration changes, as when a weapon fires.

The same setup can connect to only one weapon at a time by suitable configuration of bypass switches. This increases confidence in controlling where data goes at the expense of reconfiguring between communications to different weapons.

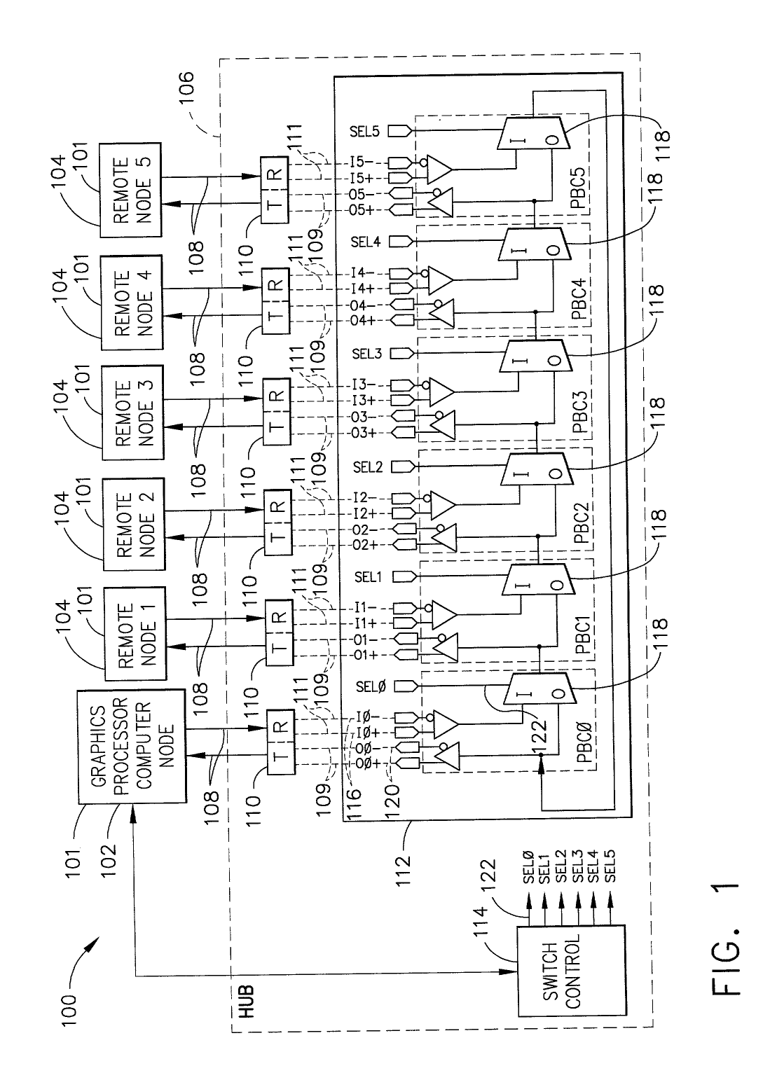

Referring now to FIG. 1, a block diagram illustrates system 100, according to one embodiment, for communication between a number of Fibre Channel nodes 101. One or more of the Fibre Channel nodes 101 may comprise a graphics processor, referred to as computer node 102. Also, the Fibre Channel nodes 101 may comprise a number of weapons carried on wing pylons, referred to as remote nodes 104. A remote node 104 may also comprise two or more concatenated, or cascaded, Fibre Channel nodes comprised of several weapons carried by a multiple launcher at a single pylon. The pylon could also have port bypass switches under local control at the wing pylon, as can be appreciated by a person of ordinary skill in the art.

System 100 includes hub 106, and each Fibre Channel node 101 is connected by a distinct fiber pair 108 to hub 106. Hub 106 may be used to facilitate connecting each of the Fibre Channel nodes 101 and its associated fiber pair 108 into a data path loop. The term “data path loop” is derived from the fact that data may be conveyed, for example, from computer node 102 through hub 106 to a first remote node 104, labeled “Remote Node 1” in FIG. 1, through first remote node 104 and return from first remote node 104 to hub 106, then back and forth from hub 106 through each remote node 104 in turn, and finally return from hub 106 to computer node 102. Thus, data may be conveyed in a loop between computer node 102 and all of the remote nodes 104 with the data in the loop returning through hub 106 between each pair of Fibre Channel nodes 101. Although one computer is shown in FIG. 1, system 100 can accommodate more than one computer, as can be appreciated by a person of ordinary skill in the art. For example, a second computer node 102 can be inserted into the loop in the same way that there is more than one remote node 104 in the loop.

Hub 106 may include optical transmitter-receiver pairs 110. Each optical transmitter-receiver pair 110, for example, may comprise a commercial fiber optic transceiver with the receiver outputs 111 and transmitter inputs 109 wired, i.e., connected, to bypass loop 112. Optical transmitter-receiver pairs 110 may be connected, as seen in FIG. 1, so as to receive optical data over a fiber pair 108 from each Fibre Channel node 101, either a computer node 102 or a remote node 104, and feed the data in electronic form to bypass loop 112. 0Further, optical transmitter-receiver pairs 110 may be connected, as seen in FIG. 1, so as to transmit optical data from bypass loop 112 to each Fibre Channel node 101, either a computer node 102 or a Fibre Channel node 104, over a fiber pair 108. Thus, all the signals from the wing pylons and the graphics processor exist within hub 106 in electrical form.

Bypass switching may be performed using bypass loop 112. Because the data path loop is arranged to return through hub 106 between each pair of Fibre Channel nodes 101, each Fibre Channel node 101 can be included in the data path loop or bypassed, i.e., excluded from the data path loop, by controlling the state of a switch within bypass loop 112. Thus, the data path loop may be routed through any combination of Fibre Channel nodes 101 and around others by control of the bypass switching. Bypass loop 112 may be controlled, for example, by switch control module 114 under command of the graphics processor at computer node 102.

Continuing with FIG. 1, for each Fibre Channel node 101, a receiver output 111 from an optical receiver portion of an optical transmitter-receiver pair 110 may be connected, for example, to an input 116 of an electronic port bypass switch 118 in bypass loop 112. For example, inputs 116 of electronic port bypass switch 118 are labeled “10+” and “10−” and are shown as differential in FIG. 1. Similarly, for each Fibre Channel node 101, a transmitter input 109 to an optical transmitter portion of an optical transmitter-receiver pair 110 may be connected, for example, from an output 120 of an electronic port bypass switch 118 in bypass loop 112. For example, outputs 120 of electronic port bypass switch 118 are labeled “O0+” and “O0−” in FIG. 1. Control for whether each Fibre Channel node 101 is bypassed or not may be achieved by connecting switch control module 114, for example, to a control line 122 of electronic port bypass switch 118. For example, control line 122 is labeled “SELO” in FIG. 1. Corresponding inputs, outputs, and control lines for other electronic port bypass switches are shown similarly labeled in FIG. 1. Bypass loop 1 12 may be implemented, for example, using circuits similar to part number VSC7127 manufactured by Vitesse, Inc or part number HDMP-0482 manufactured by Agilent, Inc.

As seen in FIG. 1, the port bypass switches, such as electronic port bypass switch 118, are connected to each other in bypass loop 112 in such a way that each Fibre Channel node 101 that is connected, via an optical transmitter-receiver pair 110, to a port bypass switch may be included in the data path loop when the port bypass switch is in a first state, and may be excluded from the data path loop while keeping the data path loop continuous, when the port bypass switch is in a second state, by bypassing data within bypass loop 112 past the Fibre Channel node 101.

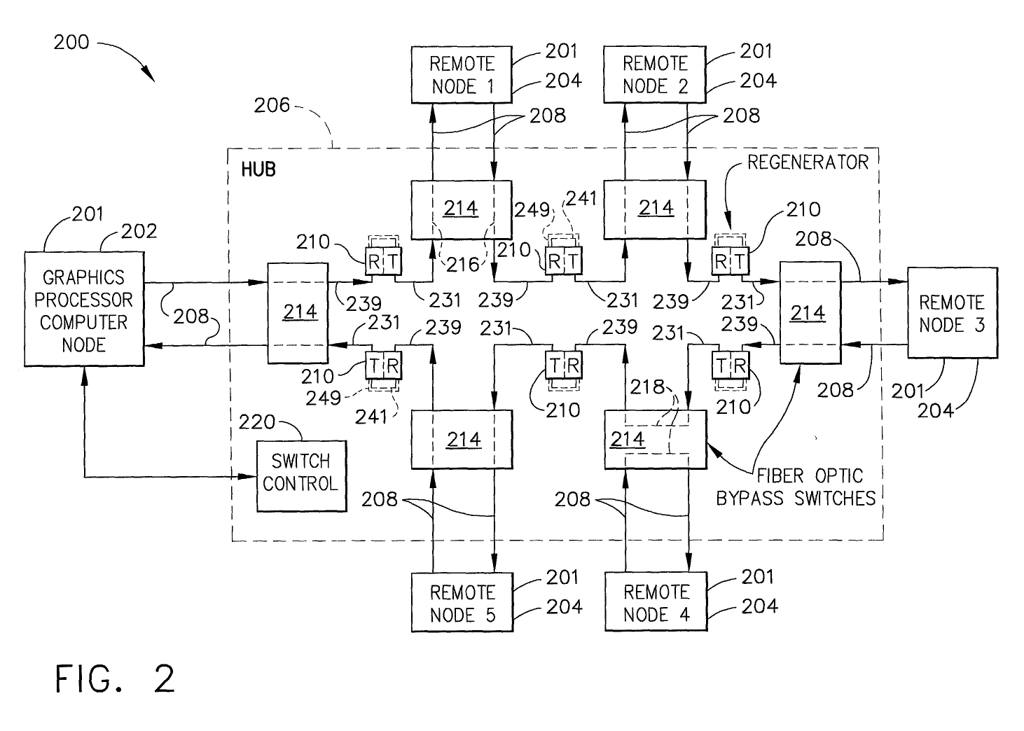

The data path loop of system 100, with electronic port bypass switching provided by bypass loop 112 under control of the graphics processor at computer node 102 can be operated as an FC-AL. The arrangement of system 100 shown in FIG. 1 provides a high link margin. Link margin may be simply characterized as extra signal power, for transmitting data, available to overcome any optical transmission losses in the system due to fibers and imperfect fiber connections. In system 100, link margin is high because a transceiver, i.e., optical transmitter-receiver pair 110, connects to each wing pylon, i.e., remote node 104. Implementation of bypass loop 112 and switch control module 114 may require proper high-speed layout of a multi-layer printed wiring board, but costs are relatively low compared to the cost of an alternative embodiment using relatively expensive fiber optic port bypass switches, described below in connection with FIG. 2.

Referring now to FIG. 2, a block diagram illustrates system 200, according to one embodiment, for communication between a number of Fibre Channel nodes 201. One or more of the Fibre Channel nodes 201 may comprise a graphics processor, referred to as computer node 202. Also, the Fibre Channel nodes 201 may include a number of weapons carried on wing pylons, referred to as remote nodes 204. A remote node 204 may also comprise two or more concatenated, or cascaded, Fibre Channel nodes comprised of several weapons carried by a multiple launcher at a single pylon. The pylon could also have port bypass switches under local control at the wing pylon, as can be appreciated by a person of ordinary skill in the art.

System 200 includes hub 206, and each Fibre Channel node 201 is connected by a distinct fiber pair 208 to hub 206. Hub 206 may be used to facilitate connecting each of the Fibre Channel nodes 201 and its associated fiber pair 208 into a data path loop. The term “data path loop” is derived from the fact that data may be conveyed, for example, from computer node 202 through hub 206 to a first remote node 204, labeled “Remote Node 1” in FIG. 2, through first remote node 204 and return from first remote node 204 to hub 206, then back and forth from hub 206 through each remote node 204 in turn, and finally return from hub 206 to computer node 202. Thus, data may be conveyed in a loop between computer node 202 and all of the remote nodes 204 with the data in the loop returning through hub 206 between each pair of Fibre Channel nodes 201. Although one computer is shown in FIG. 2, system 200 can accommodate more than one computer, as can be appreciated by a person of ordinary skill in the art. For example, a second computer node 202 can be inserted into the loop in the same way that there is more than one remote node 204 in the loop.

Hub 206 may include optical transmitter-receiver pairs 210. Each optical transmitter-receiver pair 210, for example, may comprise a commercial fiber optic transceiver used as a regenerator with the receiver outputs wired to the transmitter inputs, shown in FIG. 2 by lines 241 and 249. The optical transmitter-receiver pairs 210 may be connected, as seen in FIG. 2, so as to receive optical data 239 from each Fibre Channel node 201, which may be either a computer node 202 or a remote node 204, and feed regenerated optical data 231 to the next Fibre Channel node 201 in the data path loop. Optical data 239 and 231 may be passed, to and from each Fibre Channel node 201, through an optical port bypass switch 214. An optical port bypass switch 214 may be implemented, for example, by a micro-electromechanical device containing a repositionable mirror or a repositionable fiber end. Optical port bypass switch 214 in a first state may route light, which carries the imagery data, between hub 206 and a Fibre Channel node 201, which may be either a computer node 202 or a remote node 204, as indicated, for example, by dashed lines 216. Optical port bypass switch 214 in a second state may route light within hub 206 and bypass a Fibre Channel node 201, such as computer node 202 or remote node 204, as indicated, for example, by dashed lines 218. A computer node 202 would be bypassed only to enable operation via another computer node 202, since any data path loop needs at least one computer or processor.

A low data rate link from the graphics processor, for example, may control the state of each optical port bypass switch 214, under control of switch control module 220, which may comprise either a local central processing unit (CPU), or something as simple as a universal asynchronous receiver transmitter (UART). Alternatively, to eliminate all but electromechanical components from hub 206, each optical port bypass switch 214 may be controlled with a discrete control signal from a nearby data concentrator. Because the data path loop is arranged to return through hub 206 between each pair of Fibre Channel nodes 201, each Fibre Channel node 201 can be included in the data path loop or bypassed, i.e., excluded from the data path loop, by controlling the state of the appropriate optical port bypass switch 214. Thus, the data path loop may be routed through any combination of Fibre Channel nodes 201 and around others by control of the port bypass switches.

The data path loop of system 200, with mechanical port bypass fiber switching provided by optical port bypass switches 214 under control of the graphics processor at computer node 202, can be operated as an FC-AL. The regenerators provided by optical transmitter-receiver pairs 210 may provide additional link margin, as described above, for system 200. Thus, if system 200 has sufficient link margin, some or all optical transmitter-receiver pairs 210 may be eliminated and optical connections made directly from one optical port bypass switch 214 to the next in the data path loop in system 200.

It should be understood, of course, that the foregoing relates to preferred embodiments of the invention and that modifications may be made without departing from the spirit and scope of the invention as set forth in the following claims.

We claim:

1. A system for communication between a plurality of Fibre Channel nodes comprising:
a hub comprising a plurality of port bypass switches;
a plurality of fiber pairs, wherein each of said plurality of Fibre Channel nodes is connected by a corresponding one of said plurality of fiber pairs to a corresponding one of said plurality of port bypass switches, wherein each of said plurality of port bypass switches is configured to convey data between said hub and a corresponding one of said plurality of Fibre Channel nodes in a first state and to convey data within said hub in a second state.

2. The system of claim 1 wherein each of said plurality of Fibre Channel nodes is selected from the set consisting of a computer node and a remote node.

3. The system of claim 1 wherein each of said plurality of port bypass switches is electronic, electronically connects to said corresponding one of said plurality of Fibre Channel nodes via an optical transmitter-receiver pair, and electronically connects within a bypass loop in said hub whereby data is conveyed within said hub electronically.

4. The system of claim 1 wherein each of said plurality of bypass switches is optical and data is conveyed within said hub optically.

5. The system of claim 4 further comprising an optical regenerator wherein said optical regenerator is optically connected between a first of said plurality of port bypass switches and a second of said plurality of port bypass switches, whereby a link margin of said system is increased.

6. The system of claim 1 wherein said plurality of Fibre Channel nodes, said hub, and said fiber pairs connecting said computer node, said weapon node, and said hub comprise a Fibre Channel-Arbitrated Loop.

7. A system for data communication between a computer and a plurality of weapons carried on wing pylons comprising:
a hub connected via fiber pairs to each of a plurality of Fibre Channel nodes, wherein at least one of said plurality of Fibre Channel nodes comprises a computer and at least one of said plurality of Fibre Channel nodes comprises a weapon carried on a wing pylon, wherein said hub comprises a plurality of port bypass switches, said plurality of port bypass switches being connected in a bypass loop, and wherein each of said plurality of port bypass switches is configured to convey data between said hub and a corresponding one of said plurality of Fibre Channel nodes in a first state and to convey data within said bypass loop in a second state.

8. The system of claim 7 wherein each of said plurality of port bypass switches connects to exactly one corresponding fiber pair, and said exactly one corresponding fiber pair connects to a remote node, said remote node comprising one of said plurality of Fibre Channel nodes.

9. The system of claim 8 wherein said exactly one corresponding fiber pair connects to a remote node, said remote node comprising at least two concatenated Fibre Channel nodes for communication with at least two weapons carried by a multiple launcher at a single pylon

10. The system of claim 7 wherein each of said plurality of port bypass switches connects to exactly one corresponding fiber pair via an optical transmitter-receiver pair.

11. The system of claim 7 wherein each of said plurality of port bypass switches is electronic and data is conveyed within said bypass loop electronically.

12. The system of claim 7 wherein said plurality of Fibre Channel nodes, said hub, and said fiber pairs connecting said plurality of Fibre Channel nodes and said hub comprise a Fibre Channel-Arbitrated Loop.

13. An apparatus for data communication between a plurality of Fibre Channel nodes, comprising a hub connected via fiber pairs to a plurality of Fibre Channel nodes wherein at least one of said plurality of Fibre Channel nodes comprises a computer and at least one of said plurality of Fibre Channel nodes comprises a weapon carried on a wing pylon, said hub comprising a plurality of port bypass switches, wherein each of said plurality of port bypass switches connects to a corresponding one of said plurality of Fibre Channel nodes, and wherein at least two of said plurality of port bypass switches are connected to each other, each of said plurality of port bypass switches is configured to convey data between said hub and a corresponding one of said plurality of Fibre Channel nodes in a first state and each of said plurality of port bypass switches is configured to convey data within said hub in a second state.

14. The system of claim 13 wherein each of said plurality of port bypass switches connects to said corresponding one of said plurality of Fibre Channel nodes via an optical transmitter-receiver pair, and wherein each of said plurality of port bypass switches is electronic and data is conveyed electronically within said hub in a bypass loop.

15. The system of claim 13 wherein each of said plurality of port bypass switches is optical, wherein data is conveyed within said hub optically, and wherein said hub further comprises an optical regenerator optically connected between a first of said plurality of port bypass switches and a second of said plurality of port bypass switches in said hub, whereby a link margin of said system is increased.

16. The system of claim 13 wherein said plurality of Fibre Channel nodes, said hub, and said fiber pairs connecting said plurality of Fibre Channel nodes and said hub comprise a Fibre Channel-Arbitrated Loop.

17. An apparatus for data communication between a computer and a plurality of weapons carried on wing pylons, comprising:
a hub connected via fiber pairs to each of a plurality of Fibre Channel nodes, wherein at least one of said plurality of Fibre Channel nodes comprises a computer and at least one of said plurality of Fibre Channel nodes comprises a weapon carried on a wing pylon, said hub comprising a plurality of port bypass switches,
wherein each of said plurality of port bypass switches connects to a corresponding one of said plurality of Fibre Channel nodes via an optical transmitter-receiver pair, and wherein each of said plurality of port bypass switches is electronic, and
wherein said plurality of port bypass switches are connected in a bypass loop, data is conveyed within said bypass loop electronically, each of said plurality of port bypass switches is configured to convey data between said hub and said corresponding one of said plurality of Fibre Channel nodes in a first state, and each of said plurality of port bypass switches is configured to convey data within said bypass loop in a second state, whereby said plurality of Fibre Channel nodes, said hub, and said fiber pairs connecting said plurality of Fibre Channel nodes and said hub comprise a Fibre Channel-Arbitrated Loop.

18. A method for data communication between a computer and a plurality of weapons carried on wing pylons comprising steps of:
conveying the data between the computer and a first of a plurality of port bypass switches in a hub;
conveying the data in said hub between said first of said plurality of port bypass switches and a second of said plurality of port bypass switches; and
conveying the data between said second of said plurality of bypass switches and a first of said plurality of weapons carried on wing pylons using a fiber pair.

19. The method of claim 18 wherein said step of conveying data between said second of said plurality of port bypass switches and said first of said plurality of weapons carried on wing pylons comprises placing said second of said plurality of port bypass switches in a first state.

20. The method of claim 18 further comprising a step of bypassing said first of said plurality of weapons carried on wing pylons by placing said second of said plurality of port bypass switches in a second state, thereby conveying the data within said hub from said second of said plurality of port bypass switches to a third of said plurality of bypass switches.

21. The method of claim 18 wherein said step of conveying data between said second of said plurality of port bypass switches and said first of said plurality of weapons carried on wing pylons comprises conveying data via an optical transmitter-receiver pair.

22. The method of claim 18 wherein each of said plurality of port bypass switches is electronic and data is conveyed electronically within said hub in a bypass loop.

23. The method of claim 18 wherein each of said plurality of port bypass switches is optical and data is conveyed within a data path loop and within said hub optically.

24. The method of claim 23 further comprising a step of passing data within said hub through an optical regenerator optically connected between a first of said plurality of port bypass switches and a second of said plurality of port bypass switches in said hub, thereby increasing a link margin for transmitting data.
